(19) United States
(12) Patent Application Publication
(10) Pub. No.: US 2017/0251337 A1
(43) Pub. Date: Aug. 31, 2017

(54) PORTABLE TERMINAL, METHOD OF CONTROLLING PORTABLE TERMINAL, AND RECORDING MEDIUM

(71) Applicant: Sharp Kabushiki Kaisha, Sakai City, Osaka (JP)

(72) Inventors: Kiyotaka TAKIZUKA, Sakai City (JP); Yu YUMURA, Sakai City (JP)

(21) Appl. No.: 15/519,561

(22) PCT Filed: Feb. 8, 2016
(86) PCT No.: PCT/JP2016/053680

§ 371 Date: Apr. 17, 2017

(30) Foreign Application Priority Data
Mar. 6, 2015 (JP) 2015-045313

(51) Int. Cl. H04W 4/02; H04W 8/00

(52) U.S. Cl. CPC H04W 4/023; H04W 8/005; H04W 52/0241

(57) ABSTRACT

An object of the present invention is to measure a current position at appropriate timing and perform a predetermined process at a predetermined position. In a case where it is detected that a portable terminal (100) has entered a region in which the portable terminal (100) can make a radio communication with an access point (50), current positional information of the portable terminal (100) is obtained, and in a case where the portable terminal (100) is at a predetermined position, a predetermined process is performed.

### TECHNICAL FIELD

The present invention relates to a portable terminal which measures its position at appropriate timing, a method of controlling the portable terminal, and the like.

### BACKGROUND ART

Recently, positional information obtained by portable terminals such as smart phones, mobile phones, and tablet terminals has been used for various purposes. For example, increasing number of applications use positional information obtained by the portable terminals, and various services are provided according to positions indicated by positional information.

Much of the portable terminals have a GPS (Global Positioning System) function in order to obtain positional information. A portable terminal having the GPS function measures its current position by receiving radio waves from GPS satellites. However, there is a problem that use of the GPS function requires large power consumption. Accordingly, if a portable terminal driven by a built-in battery etc. always or frequently uses the GPS function, the portable terminal will suffer a decrease in its available time.

There have been provided techniques for subduing power consumption required by use of the GPS function. An example of such techniques is described in Patent Literature 1. Patent Literature 1 describes a positional information detecting device which subdues power consumption required in detection of its position by changing the interval for detecting its position depending on a place where a user who carries around a portable terminal is present, thereby efficiently detecting the position of the user. According to this technique, for example, in a case where the user who carries around the portable terminal is positioned in a place distant from a place where the user wishes to detect the user having arrived, the interval for measurement is made longer so that useless measurement is made as little as possible, and in a case where the user is positioned near the place where the user wishes to detect the user having arrived, the interval for measurement is made shorter so that arrival to the place can be detected as soon as possible.

### CITATION LIST

### Patent Literature

### [Patent Literature 1]

Japanese Patent Application Publication, Tokukai, No. 2006-166421 (published on Jun. 22, 2006)

### [Patent Literature 2]

Japanese Patent Application Publication, Tokukai, No. 2014-192813 (published on Oct. 6, 2014)

### SUMMARY OF INVENTION

### Technical Problem

However, the above conventional technique has a problem below.

In the technique disclosed in Patent Literature 1, in a case where a user carrying around a portable terminal is positioned distantly from the place where the user wishes to detect the user having arrived, the portable terminal can reduce useless measurement by decreasing frequency in measuring the position of the portable terminal. However, in a case where the user comes near the place where the user wishes to detect the user having arrived, the portable terminal measures its position frequently. Consequently, for example, in a case where the user keeps on moving near the place where the user wishes to detect the user having arrived, there is a possibility that the portable terminal frequently makes an unnecessary measurement, resulting in significant power consumption of a battery built in the portable terminal.

The present invention was made in view of the foregoing problem. An object of the present invention is to provide a portable terminal which obtains positional information at appropriate timing, thereby accurately specifying the current position while subduing power consumption, a method of controlling the portable terminal, and the like.

### Solution to Problem

In order to solve the foregoing problem, a portable terminal in accordance with an aspect of the present invention is a portable terminal which performs a process in accordance with a predetermined range in a case where it is specified that the portable terminal is within the predetermined range, said portable terminal including: a detection section configured to detect the portable terminal having entered a radio communication region of a device registered beforehand, based on the detection section having received a signal from the device; a positional information obtaining section configured to obtain current positional information of the portable terminal in a case where the detection section detects the portable terminal having entered the radio communication region; and a position specifying section configured to determine whether the portable terminal is within the predetermined range based on the current positional information obtained by the positional information obtaining section.

In order to solve the foregoing problem, a method in accordance with an aspect of the present invention of controlling a portable terminal is a method of controlling a portable terminal, the method causing the portable terminal to perform a process in accordance with a predetermined range, the portable terminal being specified that the portable terminal is within the predetermined range, said method including the steps of: (i) detecting the portable terminal having entered a radio communication region of a device registered beforehand, based on a reception of a signal from the device; (ii) obtaining current positional information of the portable terminal in a case where the portable terminal having entered the radio communication region is detected in the step (i); and (iii) specifying that the portable terminal is within the predetermined range in a case where a position indicated by the current positional information obtained in the step (ii) is within the predetermined range.

### Advantageous Effects of Invention

According to the aspects of the present invention, it is possible to obtain positional information at appropriate timing, thereby accurately specifying the current position while subduing power consumption.

### BRIEF DESCRIPTION OF DRAWINGS

FIG. 1 is a block diagram illustrating an example of a schematic configuration of a portable terminal in accordance with Embodiment 1 of the present invention.

FIG. 2 is a drawing illustrating an example of a data structure of access point identification information.

FIG. 3 is a drawing illustrating an example of a data structure of registered positional information.

FIG. 4 is a flowchart illustrating an example flow of a process of registering an access point for Wi-Fi in a portable terminal at home.

FIG. 5 is a flowchart illustrating an example flow of a process of measuring a current position of a portable terminal in response to a connection with an access point for Wi-Fi in a registered arrival detection place.

FIG. 6 is a flowchart illustrating an example flow of a process of measuring a current position of a portable terminal in response to a disconnection from an access point for Wi-Fi in a registered departure detection place.

### DESCRIPTION OF EMBODIMENTS

### Embodiment 1

The following description will discuss Embodiment 1 in accordance with the present invention. Embodiment 1 exemplifies a portable terminal 100 which has a positioning function such as a GPS function and is capable of measuring its current position. The portable terminal 100 is capable of making a radio communication with an access point (AP) 50 (device), in a radio communication region of the access point 50 such as Wi-Fi (registered trademark) and Bluetooth (registered trademark). Examples of the portable terminal 100 can encompass a mobile device, which moves with a user, such as a smart phone, a mobile phone, and a tablet terminal. The portable terminal 100 can, however, not be limited to a specific communication terminal, provided that (i) it has a function of obtaining its positional information and (ii) it can make a radio communication with the access point 50. Embodiment 1 will discuss an example in which the portable terminal 100 measures its current position in response to a connection with the access point 50. Such a connection is, however, not limited as such. A connection with any device, which can make a radio communication with the portable terminal 100, is applicable to the present invention.

### (Configuration of Portable Terminal 100)

The portable terminal 100 measures its position (makes a positional measurement) with use of the GPS function in response to a connection with the access point 50 which is used in a place where a user wishes to detect the user having arrived (hereinafter referred to as “arrival detection place”). Then, the user determines whether the portable terminal 100 has arrived at the arrival detection place (within a predetermined range). The arrival detection place occupies a range having a certain degree of expanse (predetermined range). In a case where the portable terminal 100 has arrived at such a range, it determines that the user of the portable terminal 100 has arrived at an arrival detection place. The access point 50 is located near the arrival detection place. Accordingly, in a case where the portable terminal 100 is within a range within which the portable terminal 100 can make a radio communication via the access point 50 (radio communication region), the portable terminal 100 can be considered as having arrived at the arrival detection place or as being near the arrival detection place.

Note, however, that (i) access points 50 are also located in places other than the arrival detection place and (ii) movable access points 50 are also located (e.g. access points of a portable type). Accordingly, a connection with an access point 50 does not always mean that the portable terminal 100 has arrived at an arrival detection place.

For this reason, the portable terminal 100 measures its position in response to a connection with the access point 50 so as to confirm whether the portable terminal 100 has arrived at the arrival detection place. This allows a reduction in the number of times of obtaining positional information as compared with the technique of Patent Literature 1 described in the Background Art. This ultimately allows the portable terminal 100 to consume lower amounts of power. Furthermore, the portable terminal 100 accurately measures its current position with use of the GPS function. As such, the portable terminal 100 can correctly determine whether the portable terminal 100 is in its arrival detection place, with use of a simpler configuration than the technique of Patent Literature 2 described in the Background Art.

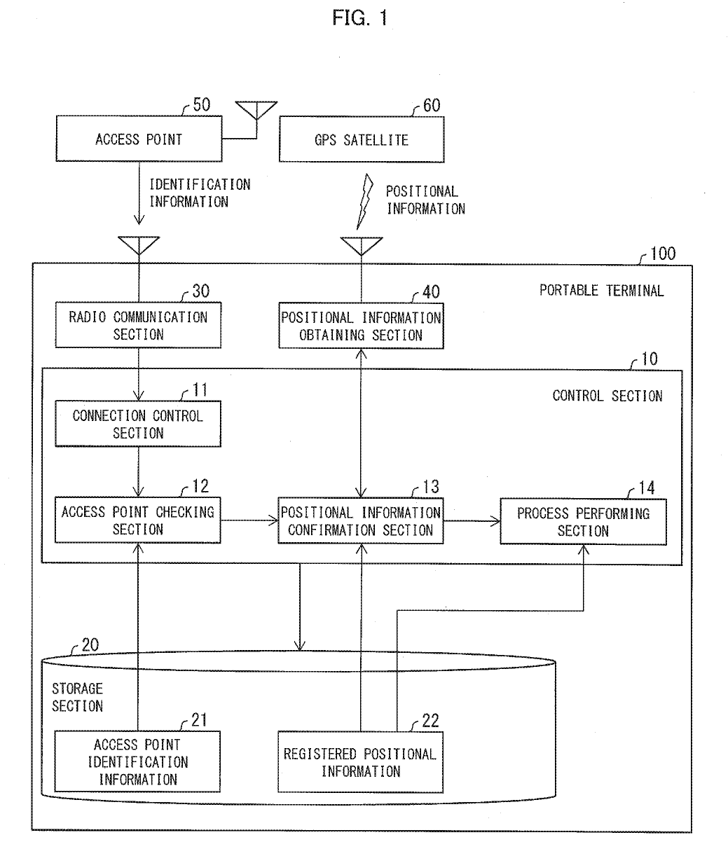

The following description will first discuss, with reference to FIG. 1, a configuration of the portable terminal 100 in accordance with Embodiment 1 of the present invention. FIG. 1 is a block diagram illustrating an example of a schematic configuration of the portable terminal 100. In FIG. 1, a single access point 50 is illustrated. The number of the access points 50 is, however, not limited as such. Two or more access points 50 can be employed. That is, the number of access points 50 which can be connected with the portable terminal 100 can be arbitrary.

The portable terminal 100 includes a control section 10, a storage section 20, a radio communication section 30, and a positional information obtaining section 40. Note that the portable terminal 100 further includes an operation input section, an audio output section, an audio input section, a display section, various sensors etc., which are not illustrated and described. This is because they are not directly related to features of Embodiment 1.

The control section 10 totally controls functions of the portable terminal 100. A configuration of the control section 10 will be detailed later.

The storage section 20 is a storage device which stores therein various data used by the portable terminal 100. In Embodiment 1, the storage section 20 stores therein at least access point identification information 21 and registered positional information 22.

The access point identification information 21 is identification information unique to the access point 50 for wireless communication such as Wi-Fi and Bluetooth, which is used for each arrival detection place. Note that the following description will discuss an example in which an MAC address (Media Access Control Address) is employed as the identification information of the access point 50. The identification information is not limited to a specific one, provided that it can identify the access point 50. For example, SSID (Service Set Identifier) etc. can be employed.

On the other hand, the registered positional information 22 includes (i) positional information indicative of an arrival detection place and (ii) information specifying processes to be performed in a case where a user arrives at respective arrival detection places. The access point identification information 21 and the registered positional information 22, which are stored in the storage section 20, will be described later with reference to specific examples.

The radio communication section 30 is provided so that the portable terminal 100 makes a radio communication with another device, and operates under control by a connection control section 11 (later described).

The positional information obtaining section 40 is controlled by the control section 10 to receive positional information indicative of a current position (place) of the portable terminal 100 from, for example, a GPS satellite 60. The positional information received by the positional information obtaining section 40 is not limited to positional information received from the GPS satellite 60, provided that the positional information indicates a current position. For example, the positional information can be positional information received from a positioning satellite system of any country, instead of the GPS satellite 60.

### (Configuration of Control Section 10)

Next, the following description will discuss a configuration of the control section 10. The control section 10 includes the connection control section 11, an access point checking section 12 (detection section), a positional information confirmation section 13 (position specifying section), and a process performing section 14.

The connection control section 11 controls communications via the radio communication section 30. For example, the connection control section 11 (i) establishes and maintains a connection made between the portable terminal 100 and the access point 50 and (ii) disconnects the portable terminal 100 from the access point 50. To be more specific, in a case where the connection control section 11 starts to make a radio connection, the connection control section 11 detects a signal which is being broadcasted within a predetermined range from an access point 50, and transmits a connection request to the access point 50. The connection control section 11 receives, as a response to the connection request transmitted to the access point 50, a signal including identification information (MAC address) unique to the access point 50. The connection control section 11 establishes, via the access point 50, a radio communication connection with use of the received MAC address. Note that the connection control section 11 can automatically transmit such a connection request or can transmit the connection request in a case where it has accepted a user's input operation (instruction for connection).

The connection control section 11 extracts the MAC address (identification information) of the access point 50, and then transmits the extracted MAC address to the access point checking section 12. The MAC address is included in the signal received from the access point 50 with which the portable terminal 100 has made a connection.

In a case where the access point checking section 12 receives, from the connection control section 11, first identification information of the access point 50 with which the portable terminal 100 has made a connection, the access point checking section 12 checks and determines whether the first identification information coincides with second identification information, of the access point 50, which is beforehand stored in (registered in) the access point identification information 21 of the storage section 20. In a case where the first identification information coincides with the second identification information, the access point checking section 12 instructs the positional information confirmation section 13 to obtain positional information indicative of a current position (to measure the current position). On the other hand, in a case where the first identification information does not coincide with the second identification information, the access point checking section 12 does not give any instruction to the positional information confirmation section 13.

Upon receipt of an instruction from the access point checking section 12, the positional information confirmation section 13 causes the positional information obtaining section 40 to operate so as to obtain, from the positional information obtaining section 40, positional information indicative of the current position of the portable terminal 100. The positional information confirmation section 13 determines whether or not a position, indicated by the positional information obtained from the positional information obtaining section 40, is located within a predetermined range which includes a place indicated by positional information stored beforehand in the registered positional information 22. Namely, the positional information confirmation section 13 determines whether the user has arrived at its arrival detection place. For example, the positional information confirmation section 13 can compare a first position, indicated by the positional information obtained from the positional information obtaining section 40, with a second position of the arrival detection place which second position is stored in the registered positional information 22 so as to determine whether or not the user is in its arrival detection place based on whether or not a difference between the first position and the second position falls within a preset error range.

In a case where the positional information confirmation section 13 determines that the user has not arrived at its arrival detection place (i.e., the user is in a place other than its arrival detection place), the MAC address, which the access point checking section 12 used while the checking, can be deleted from the access point identification information 21. This is because it has become apparent that (i) the MAC address does not correspond to an access point 50 provided in the arrival detection place and the user is in a place other than its arrival detection place or (ii) the MAC address corresponds to an access point 50 of portable type.

Such deletion of the unnecessary MAC address as above makes it possible to prevent a useless positioning in the future.

In a case where the positional information confirmation section 13 determines that the user has arrived (is present) at an arrival detection place which has been stored beforehand in the registered positional information 22, the process performing section 14 performs a process corresponding to the arrival detection place. Processes to be performed in the respective arrival detection places have been specified beforehand in the registered positional information 22.

The user having arrived (being) at its arrival detection place can be accurately determined with use of the positional information. Accordingly, the process performing section 14 can perform a predetermined process, enable a predetermined function, and/or provide a predetermined service, only for a user who is within a predetermined range which includes the arrival detection place. The process performed by the process performing section 14 will be later instantiated.

### (Access Point Identification Information 21)

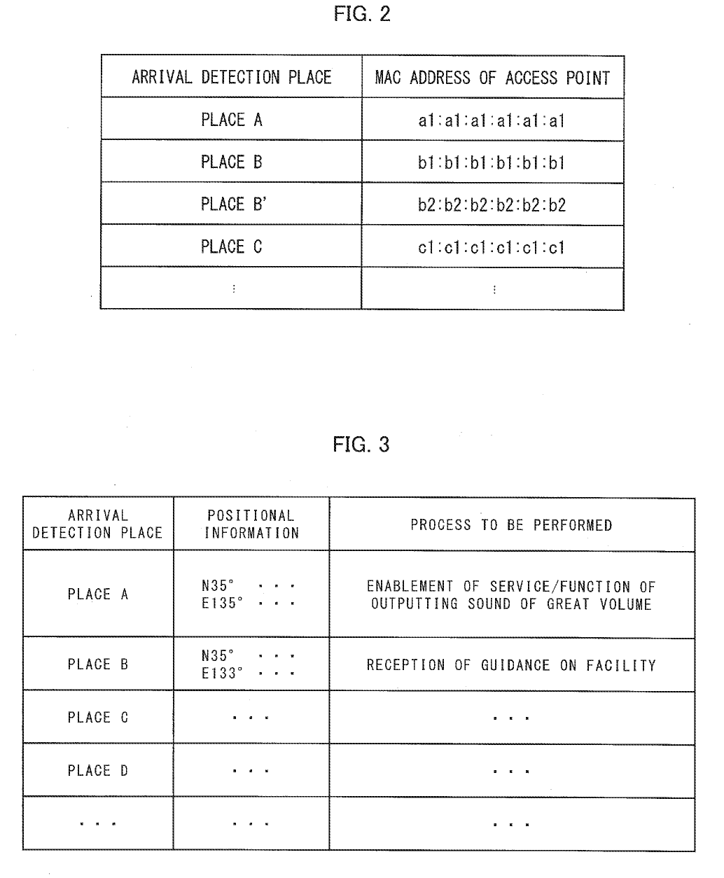

The following description will discuss the access point identification information 21 with reference to FIG. 2. FIG. 2 is a drawing illustrating an example of a data structure of the access point identification information 21.

In FIG. 2, (i) a plurality of arrival detection places and (ii) MAC addresses of the respective access points 50 (identification information of the access points) in the arrival detection places are registered such that each of the plurality of arrival detection places and a corresponding one of the MAC addresses are associated with each other. For example, a place A registered as an arrival detection place is registered so as to be associated with the MAC address (a1:a1:a1:a1:a1:a1) of the access point 50 in the place A. Similarly, a place B is registered so as to be associated with the MAC address (b1:b1:b1:b1:b1:b1). Similarly, a place B′, a place C etc. are registered so as to be associated with MAC addresses of the access points 50 used at the respective places as identification information of the access points 50 at the respective places. Each of the “place A,” the “place B” . . . in FIG. 2 can be any information which is capable of identifying a corresponding arrival detection place. For example, each of the “place A,” the “place B” (i) can be a name used when a user registered a corresponding access point 50 in a corresponding arrival detection place, (ii) can be an address or a place name of a corresponding place, (iii) can be positional information obtained at a corresponding place with use of the GPS function, or (iv) can be a name, set by a user, such as “home.” “a1:a1:a1:a1:a1:a1”, “b1:b1:b1:b1:b1:b1” etc. are merely conceptual expressions of the MAC addresses of the access points 50, and MAC addresses to be registered can be expressed in any form.

The places B and B′ can be places related to each other, such as two different places in a large scale commercial facility and different branch stores of the same chain store. More specific examples include (i) a case where the places B and B′ are “east entrance of department B” and “west entrance of department B”, respectively and (ii) a case where the places B and B′ are “store B in front of the station” and “store B at 3-chome”, respectively. Note, here, that the description exemplifies a case in which each place corresponds to a single access point 50. The present invention is, however, not limited to as such. For example, a plurality of MAC addresses can be registered for a single arrival detection place.

### (Registered Positional Information 22)

The following description will discuss, with reference to FIG. 3, the registered positional information 22 stored in the storage section 20. FIG. 3 is a drawing illustrating an example of a data structure of the registered positional information 22. As illustrated in FIG. 3, the registered positional information 22 can be a table which specifies correspondences between (i) respective positional information of arrival detection places and (ii) respective processes to be performed in the respective arrival detection places.

The access point identification information 21 and the registered positional information 22 share a record of the arrival detection place in common. For example, the arrival detection place “place A” of the access point identification information 21 is equal to the arrival detection place “place A” of the registered positional information 22. Accordingly, combined use of the access point identification information 21 and the registered positional information 22 makes it possible to identify, for each arrival detection place, an MAC address of the access point 50, positional information, and a process to be performed. Note that the access point identification information 21 and the registered positional information 22 can be stored in a single table.

According to FIG. 3, (i) information indicative of the latitude and longitude of the place A is registered as positional information of the place A and (ii) a process of enabling a service/function of outputting a sound of a great volume is registered as a process to be performed by the process performing section 14 at the place A. The place A can be, for example, a user's home. This causes the service/function of outputting a sound of a great volume to be automatically enabled while the user is at home.

Information indicative of the latitude and longitude of the place B is registered as positional information of the place B, and a process of receiving guidance on a facility is registered as a process to be performed by the process performing section 14 at the place B. The place B can be, for example, a commercial facility. This causes a user to automatically receive guidance on the commercial facility while the user is visiting the commercial facility.

Note that a predetermined process to be performed by the process performing section 14 is not limited to the examples shown in FIG. 3, provided that the predetermined process is a process regarding an arrival detection place, e.g. a process which is meaningful to perform when a user has arrived at a predetermined place or while the user is being in the predetermined place. For example, in a case where the arrival detection place is a user's home, the user's portable terminal 100 can perform (i) a process of “automatizing all user identification (personal identity verification),” (ii) a process of “causing a display screen to display so that user's personal information and user's likes and tastes are reflected,” and (iii) a process of “enabling an input of an operational instruction via audio output.” Alternatively, for example, in a case where the arrival detection place is a commercial facility, a user's portable terminal 100 can perform a process of “enabling acceptance of distribution of information on commodities dealt with there,” or a process of “enabling acceptance of distribution of coupon”.

FIG. 3 exemplifies a case where a correspondence relation for each of the arrival detection places between corresponding positional information and a corresponding process to be performed has been specified beforehand. The present invention is, however, not limited to as such. For example, there may be performed a process of adding information, in the arrival detection place, which specifies (i) positional information of an arrival detection place and (ii) a process to be performed in the arrival detection place and/or a process of updating such added information in the arrival detection place. This makes it possible to smoothly modify a predetermined process specified in the registered positional information 22.

(Flow of Process in which Access Point 50 in Arrival Detection Place is Registered in Portable Terminal 100)

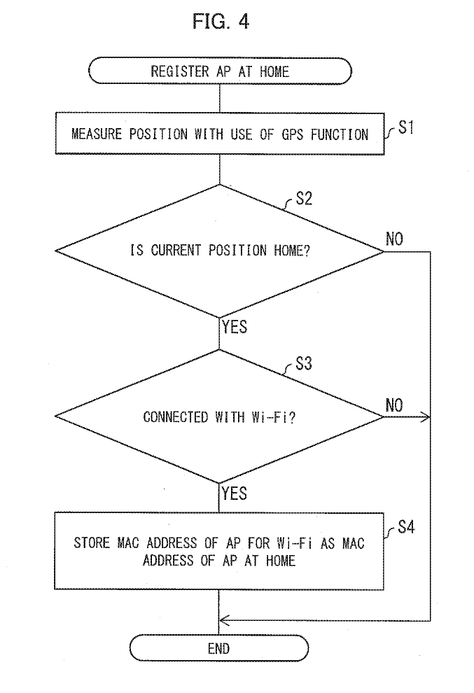

The following description will discuss, with reference to FIG. 4, a flow of a process of registering, in the portable terminal 100, (i) an access point (AP) 50 in an arrival detection place and (ii) an MAC address. The following description exemplifies a case where the arrival detection place is a user's home. FIG. 4 is a flowchart illustrating an example flow of a process of registering, at home, the access point 50 for Wi-Fi in the portable terminal 100. This process causes the access point identification information 21 to be stored. Note that, even in a case where an arrival detection place is other than home (e.g. commercial facility, sightseeing facility, work place etc.), it is possible to register an access point 50 and an MAC address by use of a process similar to the process illustrated in FIG. 4.

In a case of registering an access point 50 for Wi-Fi at home, the positional information confirmation section 13 causes the positional information obtaining section 40 to measure a position of the portable terminal 100 with use of the GPS function, and obtains positional information which results from a measurement made by the positional information obtaining section 40 (S1). Trigger for obtaining positional information in S1 can be set arbitrarily. For example, positional information can be obtained in response to an acceptance of user's operational input. Alternatively, positional information can be obtained at regular time intervals (e.g. 3 hours). Alternatively, positional information can be obtained for every predetermined moving distance (e.g. 1,000 m). Alternatively, positional information can be obtained for every predetermined number of steps (e.g. 2,000 steps).

Next, based on the positional information obtained from the positional information obtaining section 40, the positional information confirmation section 13 determines whether the current position is the user's home (S2). In S2, a first position indicated by the position information thus obtained is compared with a second position of the user's home indicated by the registered positional information 22. It can be then determined whether or not the current position is the user's home, based on whether or not a difference between the first position and the second position falls within a predetermined error range. Alternatively, the positional information confirmation section 13 can make a determination in S2 by urging the user to enter whether the user is at home. In this case, the user can be urged to enter information by, for example, displaying a message for confirming whether the user is at home.

In a case where the positional information confirmation section 13 determines in S2 that the current position is the user's home (YES in S2), the positional information confirmation section 13 instructs the access point checking section 12 to register the MAC address of the user's home. In cases where (i) the access point checking section 12 receives the instruction and (ii) a connection with Wi-Fi is confirmed (YES in S3), the access point checking section 12 obtains, from the connection control section 11, an MAC address of the access point 50 which is being connected with Wi-Fi. Then, the access point checking section 12 stores (registers), in the access point identification information 21, the MAC address thus obtained as the MAC address of the user's home (e.g. place A in FIG. 2) (S4).

Note, however, that even in a case of the MAC address registered in the access point identification information 21 at the user's home as above, there is a possibility that the MAC address is that of the access point 50 of a portable type which the user carries around. As such, there is a possibility that the MAC address is not that of the access point 50 in the user's home. Accordingly, it is not always correct to understand that the user is currently at home, merely based on the fact that the MAC address of the user's home, which address is registered in the access point identification information 21, is identical to the MAC address of the access point 50 with which the portable terminal 100 is currently connected. Therefore, the portable terminal 100 measures its position in response to a connection with the access point 50, and then confirms whether the portable terminal 100 has arrived at the arrival detection place.

(Flow of Process of Measuring Current Position in Response to Connection with Access Point 50 in Arrival Detection Place)

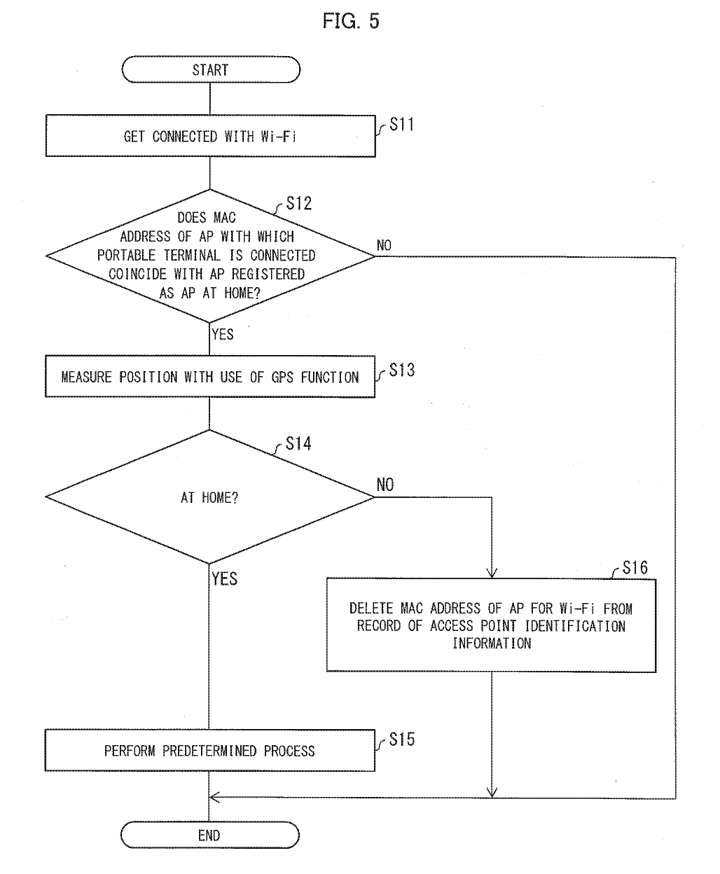

The following description will discuss, with reference to FIG. 5, a flow of a process of measuring a current position of the portable terminal 100 in response to a connection with the access point 50 in an arrival detection place. FIG. 5 is a flowchart illustrating an example flow of a process of measuring a current position of the portable terminal 100 in response to a connection with the access point 50 for Wi-Fi in a registered arrival detection place. Note, here, that an example in which an arrival detection place is a user's home is described.

In a case where the portable terminal 100, which is carried around the user, gets connected with an access point 50 for Wi-Fi (S 11), the connection control section 11 obtains, via the radio communication section 30, an MAC address of the access point 50 with which the portable terminal 100 is connected, and then transmits the MAC address thus obtained to the access point checking section 12. Then, the access point checking section 12 checks and determines whether the MAC address received from the connection control section 11 coincides with an MAC address which is registered in the access point identification information 21 so as to be associated with an arrival detection place (user's home in this example) (S12, detection step). In a case where a plurality of arrival detection places are registered in the access point identification information 21 as in the example of FIG. 2, the access point checking section 12 determines whether an MAC address, which coincides with the MAC address received from the connection control section 11, is registered.

Note that the access point checking section 12 can make a determination in S12 (i) immediately after the MAC address of the access point 50 is obtained or (ii) at a time when a radio communication becomes available via the access point 50.

In a case where the access point checking section 12 determines in S12 that the MAC address received from the connection control section 11 is different from the MAC address which is registered in the access point identification information 21 so as to be associated with the user's home (NO in S12), the flow illustrated in FIG. 5 is ended. On the other hand, in a case where the access point checking section 12 determines in S12 that the MAC address received from the connection control section 11 coincides with the MAC address which is registered in the access point identification information 21 so as to be associated with the user's home (YES in S12), the access point checking section 12 instructs the positional information confirmation section 13 to obtain positional information. Upon receipt of such an instruction, the positional information confirmation section 13 causes the positional information obtaining section 40 to make a measurement of a current position of the portable terminal 100 with use of the GPS function, and then obtains positional information which results from such a measurement (S13, positional information obtaining step). Next, the positional information confirmation section 13 determines whether the user is currently at home, based on the positional information indicative of the current position which information has been obtained from the positional information obtaining section 40 (S14, position specifying step).

In a case where the positional information confirmation section 13 determines in S14 that the user is currently at home (YES in S 14), the positional information confirmation section 13 notifies the process performing section 14 that the user is at home (has arrived at home). Then, the process performing section 14 thus notified performs a process specified in the registered positional information 22 as a process to be performed at home (S15), and the flow illustrated in FIG. 5 is ended.

On the other hand, in a case where the positional information confirmation section 13 determines in S14 that the user is currently not at home (NO in S14), the positional information confirmation section 13 notifies the access point checking section 12 that the user is currently not at home. The access point checking section 12 thus notified deletes, from the access point identification information 21, the record (combination of the arrival detection place and the MAC address) used during the checking in S12 (S16), and the flow illustrated in FIG. 5 is ended.

### Embodiment 2

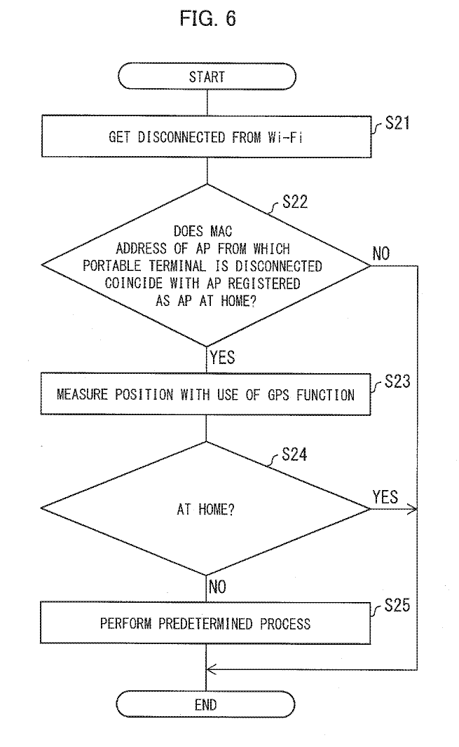

The portable terminal 100 of Embodiment 1 exemplifies the case where the portable terminal 100 measures its current position in response to the connection with the access point 50 in an arrival detection place so as to determine whether a user has arrived at its arrival detection place, and performs a predetermined process. However, the present invention is not limited to the case exemplified by Embodiment 1. For example, the portable terminal 100 can measure its current position in response to a disconnection from the access point 50 in a place, where a user wishes to detect the user having departed (hereinafter referred to as “departure detection place”), so as to determine whether the user is in a place (in a predetermined range) other than the departure detection place, and then performs a predetermined process in accordance with a detected result. The following description will discuss such an embodiment with reference to FIG. 6. For convenience, members having functions identical to those described in Embodiment 1 are given identical reference numerals, and explanations thereof are omitted.

(Flow of Process of Measuring Current Position in Response to Disconnection from Access Point 50 in Departure Detection Place)

The following description will discuss, with reference to FIG. 6, a flow of a process of measuring a current position of the portable terminal 100 in response to a disconnection from an access point 50 in a departure detection place. FIG. 6 is a flowchart illustrating an example flow of a process of measuring a current position of the portable terminal 100 in response to a disconnection from the access point 50 for Wi-Fi in the user's home, which access point 50 has been registered. The following description will discuss an example in which the departure detection place is a user's home.

In a case where the portable terminal 100 carried around by the user gets disconnected from an access point 50 for Wi-Fi (S21), the connection control section 11 transmits to the access point checking section 12, via the radio communication section 30, an MAC address of the access point 50 from which the portable terminal 100 gets disconnected. Then, the access point checking section 12 checks and determines whether the MAC address received from the connection control section 11 coincides with an MAC address which is registered in the access point identification information 21 so as to be associated with the departure detection place (user's home in this example) (S22, detection step). A plurality of departure detection places can be registered in the access point identification information 21, as with the case of the arrival detection places in the example of FIG. 2.

In a case where the access point checking section 12 determines in S22 that the above two MAC addresses do not coincide with each other (NO in S22), the flow illustrated in FIG. 6 is ended. On the other hand, in a case where the access point checking section 12 determines in S22 that the above two MAC addresses coincide with each other (YES in S22), the access point checking section 12 instructs the positional information confirmation section 13 to obtain positional information. The positional information confirmation section 13 thus instructed causes the positional information obtaining section 40 to measure a current position with use of the GPS function, and then obtains positional information which results from the measurement made by the positional information obtaining section 40 (S23, positional information obtaining step). Then, the positional information confirmation section 13 determines whether at present the user has left the user's home, based on the positional information, indicative of the current position, which has been obtained from the positional information obtaining section 40 (S24, position specifying step).

In a case where the positional information confirmation section 13 determines in S24 that the user is currently not at home (NO in S24), the positional information confirmation section 13 notifies the process performing section 14 that the user has left (departed from) the user's home. The process performing section 14 thus notified performs a process specified, in the registered positional information 22, as a process to be performed when the user has left the user's home (S25), and the flow illustrated in FIG. 6 is ended.

On the other hand, in a case where the positional information confirmation section 13 determines in S24 that the user is currently at home (YES in S24), the flow illustrated in FIG. 6 is ended.

In a case where a departure detection place is set to be broader than a range within which the access point 50 in the departure detection place can make a communication, the portable terminal 100 is still in the departure detection place when the portable terminal 100 has got disconnected from the access point 50. It follows that, in a case where the positional information confirmation section 13 has obtained positional information immediately after a determination in S22, there is a possibility that the portable terminal 100 cannot detect the user having left the user's home. In view of the circumstances, the process in S23 can be performed after a given length of time (e.g. 5 minutes) has elapsed since a determination was made in S22. Alternatively, the process in S23 can be performed after the portable terminal 100 is confirmed to be moving. Note that whether the portable terminal 100 is moving can be confirmed by using sensor information received from, for example, an acceleration sensor (not illustrated), a geomagnetic sensor (not illustrated) etc. included in the portable terminal 100.

There is a possibility that it is not possible to correctly determine that the portable terminal 100 is currently outside (within a predetermined range) a departure detection place (user's home in this example), in a case of merely detecting the portable terminal 100 having left a range within which the portable terminal 100 can make a radio communication via an access point 50. This is because a case is envisioned where the access point 50 is a movable one. Accordingly, it is necessary that positional information is obtained so that whether the portable terminal 100 has left a departure detection place is correctly determined. Note, however, that it is desirable that the number of obtaining positional information is held down so that power consumption is subdued.

According to the above arrangement, in a case where the portable terminal 100 has departed from the range within which the portable terminal 100 can make a radio communication via the access point 50 registered beforehand, current positional information on the portable terminal 100 is obtained and it is determined whether the portable terminal 100 is outside the user's home or not. This allows positional information to be obtained only when it is detected that the portable terminal 100 has departed from the range within which the portable terminal 100 can make a radio communication via the access point 50, thereby specifying that the user is currently outside the user's home. Accordingly, obtainment of positional information is made at appropriate timing and use of the positional information can be reduced, so that it is possible to subdue power consumption of the portable terminal. Such an arrangement is effective when it is desired to perform a predetermined process outside the user's home.

### Embodiment 3

For example, (i) in a case where a portable terminal 100 accepts a user's operation of switching between enabling and disabling of a radio communication function of the portable terminal 100 or (ii) in a case where the portable terminal 100 accepts a user's turn-on or turn-off operation of the portable terminal 100, there is a possibility that a radio communication is connected or disconnected between the portable terminal 100 and the access point 50, regardless of (a) the user arriving at an arrival detection place or (b) the user leaving a departure detection place. Similarly, (i) in a case where the portable terminal 100 undergoes a transition to a sleep state or (ii) in a case where the portable terminal 100 undergoes a transition from a sleeping state to an operating state, it is likely that a radio communication is connected or disconnected between the portable terminal 100 and the access point 50. Measuring a position of the portable terminal 100 is likely to be useless in such a case where no movement of the user is involved.

In view of the circumstances, the access point checking section 12 is configured to further detect whether the portable terminal 100 is moving. The positional information confirmation section 13 can therefore be configured to obtain current positional information of the portable terminal 100, (i) in a case where a movement of the portable terminal 100 is detected before a connection of the portable terminal 100 with the access point 50 is detected or (ii) in a case where a movement of the portable terminal 100 is detected before a disconnection of the portable terminal 100 from the access point 50 is detected. With the configuration, even in a case where the connection control section 11 has detected (i) a connection of the portable terminal 100 with the access point 50, (ii) a disconnection of the portable terminal 100 from the access point 50, or (iii) a reconnection of the portable terminal 100 with the access point 50, the portable terminal 100 will not obtain any positional information, as long as the above (i), (ii), or (iii) has not been detected while the portable terminal 100 and a user have been moving together. Whether the portable terminal 100 is moving can be determined by using sensor information received from, for example, an acceleration sensor (not illustrated), a geomagnetic sensor (not illustrated) etc. included in the portable terminal 100.

The following description will discuss, with reference to FIG. 5, an example flow of a process of the portable terminal 100 in accordance with Embodiment 3. For convenience, steps performing processes identical to those of the steps which have already been described are not explained here.

In S12 in FIG. 5, the access point checking section 12 checks and determines whether an MAC address received from the connection control section 11 coincides with an MAC address which is registered in the access point identification information 21 so as to be associated with an arrival detection place (user's home in this example). In a case where the access point checking section 12 determines that the above two MAC addresses coincide with each other (YES in S12), the access point checking section 12 obtains sensor information from the acceleration sensor (not illustrated), the geomagnetic sensor (not illustrated) etc., and confirms whether the portable terminal 100 is currently moving or not (movement confirmation step). In a case where the portable terminal 100 is currently moving, the access point checking section 12 instructs the positional information confirmation section 13 to obtain positional information. The positional information confirmation section 13 thus instructed causes the positional information obtaining section 40 to measure the current position of the portable terminal 100 with use of the GPS function, and obtains positional information which results from the measurement by the positional information obtaining section 40 (S13).

Similar processes can be performed in S22 and S23 in FIG. 6.

### Embodiment 4

Control blocks (especially, the connection control section 11, the access point checking section 12, the positional information confirmation section 13, and the process performing section 14) and the position information obtaining section 40 of the portable terminal 100 can be realized (i) by a logic circuit (hardware) provided in an integrated circuit (IC chip) or the like or (ii) by software as executed by a central processing unit (CPU).

In the latter case, the portable terminal 100 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded, and the like. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

### [Summary]

A portable terminal 100 in accordance with aspect 1 of the present invention is a portable terminal which performs a process in accordance with a predetermined range in a case where it is specified that the portable terminal is within the predetermined range, said portable terminal including: a detection section (access point checking section 12) configured to detect the portable terminal having entered a radio communication region of a device (access point 50) registered beforehand, based on the detection section having received a signal from the device; a positional information obtaining section 40 configured to obtain current positional information of the portable terminal in a case where the detection section detects the portable terminal having entered the radio communication region; and a position specifying section (position information confirmation section 13) configured to determine whether the portable terminal is within the predetermined range based on the current positional information obtained by the positional information obtaining section.

In a case where a portable terminal has entered a radio communication region of a device registered beforehand, there is a high possibility that the portable terminal is within a predetermined range. However, since there can be a case where the device is a movable device, there is a possibility that merely detecting that the portable terminal has entered the radio communication region of the device does not make it possible to correctly determine that the portable terminal is currently within the predetermined range. Accordingly, in order to correctly determine that the portable terminal is currently within the predetermined range, it is desirable to obtain positional information. Furthermore, since a portable terminal is in general driven by a built-in battery etc., it is desirable to reduce the number of obtaining positional information so as to subdue power consumption.

According to the above aspect, in a case where the portable terminal receives a signal from the device registered beforehand and it is detected that the portable terminal has entered the radio communication region of the device, the portable terminal obtains its current positional information and determines whether the portable terminal is within the predetermined range or not. This makes it possible for the portable terminal to obtain positional information only in a case where it is detected that the portable terminal has entered the radio communication region of the device, thereby specifying that the portable terminal is currently within the predetermined range. Accordingly, obtainment of positional information is made at appropriate timing and the number of use of the positional information is reduced, so that it is possible to subdue power consumption of the portable terminal.

A portable terminal in accordance with aspect 2 of the present invention may be an arrangement of the aspect 1, further comprising a storage section 20 which stores therein identification information for the device, the detection section deletes the identification information from the storage section, in a case where (i) the detection section detects the portable terminal having entered the radio communication region of the device and (ii) the position specifying section determines that the portable terminal is not within the predetermined range.

According to the above aspect, in a case where (i) the portable terminal detects the portable terminal having entered the radio communication region of the device based on the identification information of the device and determines that the portable terminal is not within the predetermined range, the portable terminal deletes the identification information from the storage section. This makes it possible to prevent, subsequently, useless obtainment of positional information based on the identification information of the device which can move from within the predetermined range.

A portable terminal in accordance with aspect 3 of the present invention may be an arrangement of the aspect 1 or 2, wherein the detection section detects the portable terminal having left the radio communication region, based on the detection section having no longer received any signal from the device, and in a case where the portable terminal has left the radio communication region, the position specifying section obtains current positional information of the portable terminal, and then determines, based on the current positional information, whether the portable terminal is present within the predetermined range or not.

There can be a case where the device is movable one. Accordingly, there is a possibility that merely detecting that the portable terminal has departed from the radio communication region of the device does not make it possible to correctly determine that the portable terminal is currently within the predetermined range. Accordingly, positional information is obtained in order to correctly determine whether the portable terminal is within the predetermined range or not. It is desirable that the number of obtaining positional information is small in order to subdue power consumption.

According to the above aspect, in a case where the portable terminal has departed from the radio communication region of the device registered beforehand, the portable terminal obtains its current positional information and determines whether the portable terminal is present the predetermined range or not. This makes it possible for the portable terminal to obtain positional information only in a case where it is detected that the portable terminal has departed from the radio communication region of the device, thereby specifying that the portable terminal is currently within the predetermined range. Accordingly, obtainment of positional information is made at appropriate timing and the number of use of the positional information is reduced, so that it is possible to subdue power consumption of the portable terminal.

A portable terminal in accordance with aspect 4 of the present invention may be an arrangement of the aspect 3, wherein the position specifying section obtains the current positional information of the portable terminal, (i) in a case where a given length of time has elapsed since the portable terminal left the radio communication region, or (ii) in a case where the portable terminal is moving after the portable terminal left the radio communication region.

In a case where positional information is obtained immediately after it is detected that the portable terminal has departed from the radio communication region, there is a possibility that it cannot be correctly determined whether the portable terminal is within the predetermined range or not.

According to the above aspect, (i) in a case where a given length of time has elapsed since it was detected that the portable terminal left the radio communication region, or (ii) in a case where the portable terminal is determined as moving after it was detected the portable terminal departed from the radio communication region, current positional information of the portable terminal is obtained. This makes it possible for the portable terminal to obtain positional information at timing when the portable terminal has completely moved into the predetermined range or at timing when it is confirmed that the portable terminal is moving into the predetermined range. Such an aspect is effective, for example, in a case where it is desired that a predetermined process is performed at a place distant from the radio communication region.

A method in accordance with aspect 5 of the present invention of controlling the portable terminal 100 is a method of controlling a portable terminal, the method causing the portable terminal to perform a process in accordance with a predetermined range, the portable terminal being specified that the portable terminal is within the predetermined range, said method comprising the steps of: (i) detecting the portable terminal having entered a radio communication region of a device (access point 5) registered beforehand, based on a reception of a signal from the device (S12, S22); (ii) obtaining current positional information of the portable terminal in a case where the portable terminal having entered the radio communication region is detected in the step (i) (S13, S23); and (iii) specifying that the portable terminal is within the predetermined range in a case where a position indicated by the current positional information obtained in the step (ii) is within the predetermined range (S14, S24). The above aspect yields an effect similar to that of the aspect 1.

The portable terminals in accordance with the aspects of the present invention may be realized by a computer. In this case, the present invention also encompasses a control program for a portable terminal which program causes a computer to operate sections (software elements) of the portable terminals so as to realize the portable terminals by the computer, and a computer-readable storage medium in which the control program is stored.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is usable for an electronic device movable with a user.

### REFERENCE SIGNS LIST

10 Control section
11 Connection control section
12 Access point checking section (detection section)
13 positional information confirmation section (position specifying section)
20 Storage section
40 Positional information obtaining section
50 Access point (device)
100 Portable terminal
S12, S22 Detection step
S13, S23 Positional information obtaining step
S14, S24 Position specifying step

1. A portable terminal which performs a process in accordance with a predetermined range in a case where it is specified that the portable terminal is within the predetermined range,
said portable terminal comprising:
a detection section configured to detect the portable terminal having entered a radio communication region of a device registered beforehand, based on the detection section having received a signal from the device;
a positional information obtaining section configured to obtain current positional information of the portable terminal in a case where the detection section detects the portable terminal having entered the radio communication region; and
a position specifying section configured to determine whether the portable terminal is within the predetermined range based on the current positional information obtained by the positional information obtaining section.

2. The portable terminal as set forth in claim 1, further comprising a storage section which stores therein identification information for the device,
the detection section deletes the identification information from the storage section, in a case where (i) the detection section detects the portable terminal having entered the radio communication region of the device and (ii) the position specifying section determines that the portable terminal is not within the predetermined range.

3. The portable terminal as set forth in claim 1 or 2, wherein
the detection section detects the portable terminal having left the radio communication region, based on the detection section having no longer received any signal from the device, and
in a case where the portable terminal has left the radio communication region, the position specifying section obtains current positional information of the portable terminal and then determines, based on the current positional information, whether the portable terminal is present within the predetermined range or not.

4. The portable terminal as set forth in claim 3, wherein the position specifying section obtains the current positional information of the portable terminal, (i) in a case where a given length of time has elapsed since the portable terminal left the radio communication region or (ii) in a case where the portable terminal is moving after the portable terminal left the radio communication region.

5. A method of controlling a portable terminal, the method causing the portable terminal to perform a process in accordance with a predetermined range, the portable terminal being specified that the portable terminal is within the predetermined range,
said method comprising the steps of:
(i) detecting the portable terminal having entered a radio communication region of a device registered beforehand, based on a reception of a signal from the device;
(ii) obtaining current positional information of the portable terminal in a case where the portable terminal having entered the radio communication region is detected in the step (i); and
(iii) specifying that the portable terminal is within the predetermined range in a case where a position indicated by the current positional information obtained in the step (ii) is within the predetermined range.

6. A control program for causing a computer to function as a portable terminal as set forth in claim 1, the control program causing the computer to function as the detection section and the position specifying section.
